(19) United States
(12) Patent Application Publication
(10) Pub. No.: US 2025/0060564 A1
(43) Pub. Date: Feb. 20, 2025

(54) OPTICAL SYSTEM, CAMERA MODULE, AND MOBILE TERMINAL

(71) Applicant: LG INNOTEK CO., LTD., Seoul (KR)

(72) Inventor: Jae Wook JUNG, Seoul (KR)

(21) Appl. No.: 18/722,793

(22) PCT Filed: Dec. 21, 2022
(86) PCT No.: PCT/KR2022/020997

§ 371 Date: Jun. 21, 2024

(30) Foreign Application Priority Data
Dec. 22, 2021 (KR) 10-2021-0185321

(51) Int. Cl. G02B 13/00; G02B 9/62; G03B 17/12; H04N 23/55

(52) U.S. Cl. CPC G02B 13/0045; G02B 9/62; G03B 17/12; H04N 23/55

(57) ABSTRACT

A camera module disclosed in an embodiment of the invention includes a lens barrel having a through hole therein; and an optical system disposed in the through hole of the lens barrel and having a plurality of lenses which an optical axis is aligned from an object side toward a sensor side, wherein a sensor-side lens closest to an image sensor among the plurality of lenses includes an object-side surface and a sensor-side surface, the sensor-side lens has a length in a first direction orthogonal to the optical axis longer than a length in a second direction, the sensor-side lens includes an outer protrusion protruding on one side in the second direction, and the sensor-side surface of the sensor-side lens may have an asymmetrical shape in a shape of a lens surface from the optical axis to an end of an effective region in the first direction and a lens surface from the optical axis to an end of an effective region in the second direction.

### TECHNICAL FIELD

An embodiment relates to an optical system, a camera module and a mobile terminal including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

In addition, recently, as the front display of smartphones equipped with a camera module is required, a form factor of the front camera is continuously changing, and as a result, an under-display camera that hides the front camera under the display is being applied.

However, when the camera is placed at the bottom of the display, problems such as deterioration in image quality of the camera module, reduction in brightness, and occurrence of ghosts/flares occur due to loss of light due to the display panel. In particular, as brightness drops to 20% of the existing level, a new optical structure that can compensate for the brightness of the camera is required.

Therefore, an optical system with a new structure that can have improved resolution and improved illuminance regardless of the position of the camera is required.

### DISCLOSURE

### Technical Problem

An embodiment provides a camera module with a new lens optical system. An embodiment of the invention can provide a camera module with a new lens barrel. The embodiment provides an optical system and a camera module that have improved resolution, improved illuminance, and improved optical characteristics and can be miniaturized. An embodiment of the invention may provide a mobile terminal having a camera module.

### Technical Solution

A camera module according to an embodiment of the invention includes a lens barrel having a through hole therein; and an optical system disposed in the through hole of the lens barrel and having a plurality of lenses which an optical axis is aligned from an object side toward a sensor side, wherein a sensor-side lens closest to an image sensor among the plurality of lenses includes an object-side surface and a sensor-side surface, the sensor-side lens has a length in a first direction orthogonal to the optical axis longer than a length in a second direction, the sensor-side lens includes an outer protrusion protruding on one side in the second direction, and the sensor-side surface of the sensor-side lens may have an asymmetrical shape in a shape of a lens surface from the optical axis to an end of an effective region in the first direction and a lens surface from the optical axis to an end of an effective region in the second direction.

According to an embodiment of the invention, the sensor-side lens includes a first straight portion disposed on one side in the second direction with respect to the optical axis and a second straight portion disposed on the other side in the second direction, and the first and second straight portions are disposed between outer arc portions of the sensor-side lens. According to an embodiment of the invention, the outer protrusion protrudes outward from the second straight portion, and the outer protrusion may be disposed within a virtual circle of the outer arc portion of the sensor-side lens.

According to an embodiment of the invention, the sensor-side surface of the sensor-side lens may have a freeform surface and may have a distance from the optical axis to the end of the effective region in the first direction is greater than a distance to the end of an effective region in the second direction. According to an embodiment of the invention, the sensor-side surface of the sensor lens may have a maximum effective distance at a point having an angle of 50±3 degrees from an axis extending in the first direction with respect to the optical axis. According to an embodiment of the invention, the angle to the point having the maximum effective distance of the sensor-side surface in the first direction based on a center of the sensor-side lens is greater than the angle to the point of the maximum effective distance of the object-side surface.

According to an embodiment of the invention, first and second seating portions disposed on both sides of the second direction along a lower circumference of the lens barrel include, wherein the first and second seating portions include a concave seating groove and guide protrusions on the both sides of the seating portion, and the outer protrusions may be inserted into the first or second seating portion. According to an embodiment of the invention, a bottom of the seating groove may be disposed closer to the sensor side rather than a step portion of the lens barrel on which a flange portion of the sensor-side lens is seated.

According to an embodiment of the invention, the object-side surface of the sensor-side lens includes a first outer portion between the end of the effective region in the first direction and the flange portion, and a second outer portion between the end of the effective region in the second direction and the flange portion, and the first outer portion and the second outer portion may have different shapes. The second outer portion may have a lower depth than a depth of the first outer portion and may have a plurality of inclined surfaces. The first outer portion has a first curved surface connected to an end of the effective region, a second curved surface connected to the flange portion, and a flat surface between the first and second curved surfaces, and may overlap in a direction orthogonal to a sensor-side surface of the flange portion.

According to an embodiment of the invention, a spacer disposed on the flange portion of the sensor-side lens include, and the spacer may include first- and second-line portions in a form of straight lines on both sides of the second direction. The spacer may have an internal penetration hole of a non-circular shape. A periphery of the penetration hole of the spacer may include a first curved portion on one side in the second direction, a first line portion extending in a straight line from the first curved portion, a second curved portion in a diagonal region, and a second line portion on one side in the first direction.

A camera module according to an embodiment of the invention includes first to sixth lenses which an optical axis is aligned from an object side toward a sensor side; and a plurality of spacers each disposed on an outer circumference between the first to sixth lenses, wherein the sixth lens is closest to the image sensor and has an object-side surface and a sensor-side surface, and the sixth lens has a length of a first direction orthogonal to the optical axis longer than a length of a second direction, the sixth lens includes first and second straight portions in a form of straight lines on both sides of the second direction between outer arc portions, and a sensor-side spacer closest to the sixth lens among the plurality of spacers has a penetration hole therein and has third and fourth straight portions on both sides in the second direction, and at least one of the sensor-side surface and the object-side surface of the sixth lens may have a freeform surface.

According to an embodiment of the invention, the sensor-side surface or the object-side surface of the sixth lens may have an asymmetrical shape in a shape of a lens surface from the optical axis to an end of an effective region in the first direction and a lens surface from the optical axis to an end of an effective region in the second direction. The sensor-side spacer may have a penetration hole of a non-circular shape.

According to an embodiment of the invention, the sixth lens includes an outer protrusion protruding outward from any one of the first and second straight portions, and the outer protrusion may protrude more outward than one of the third and fourth straight portions of the sensor-side spacer. The sensor-side surface and the object-side surface of the sixth lens may have free-form surface.

A mobile terminal according to an embodiment of the invention may include the camera module disclosed above.

### Advantageous Effects

A camera module according to an embodiment of the invention may have improved optical characteristics. In detail, the camera module may have improved aberration characteristics, resolution, etc. as the plurality of lenses have a set shape, refractive power, thickness, spacing, etc. A camera module according to an embodiment of the invention can have good optical performance not only in the center portion of the field of view (FOV) but also in the periphery portion. A camera module according to an embodiment of the invention may be provided in a slim and compact structure.

The camera module according to an embodiment of the invention can improve the relative illumination of the light incident on the image sensor when the light passes through the last lens and moves to the image sensor. In detail, the peripheral light ratio of the light passing through the last lens and incident on the image sensor portion may be 30% or more or 35% or more. Therefore, the camera module can compensate for the decrease in light quantity that may vary depending on the position of the display device. That is, the camera module can secure a light quantity of sufficient brightness without being affected by the position of the display device, thereby implementing an improved resolution.

In addition, since the light quantity and resolution of the optical system can be improved without increasing the size of the optical system or the size of the aperture lens, it is possible to achieve miniaturization of the optical system and camera module while having an improved light quantity size. According to an embodiment of the invention, the optical reliability of the camera module can be improved. Additionally, the reliability of the camera module and the mobile terminal having it can be improved.

### DESCRIPTION OF DRAWINGS

FIG. 1 is s an example of a side cross-sectional view in a first direction of a camera module according to an embodiment of the invention.

FIG. 2 is a side cross-sectional view of the camera module of FIG. 1 in a second direction.

FIG. 3 is a perspective view of the lens barrel of the camera module of FIG. 1.

FIG. 4 is a bottom view of the lens barrel of FIG. 3.

FIG. 5 is a bottom view of the lens barrel and the last lens of FIG. 1.

FIG. 6 is an example of coupling the flange portion of the last lens to the lens barrel of FIG. 5.

FIGS. 7 and 8 are perspective views of the last lens in FIG. 5.

FIGS. 9 and 10 are object-side views of the last lens in FIGS. 7 and 8.

FIGS. 11 and 12 are the sensor-side views of the last lens in FIGS. 7 and 9.

FIGS. 13 and 14 are diagrams for explaining the flange portion of the last lens of FIGS. 7 and 8.

FIG. 15 is a side cross-sectional view of the last lens of FIGS. 7 and 8 in the first direction.

FIG. 16 is a partial side cross-sectional view of the last lens of FIGS. 7 and 8 in the second direction.

FIG. 17 is a plan view showing a spacer disposed on the last lens according to an embodiment of the invention.

FIG. 18 is a diagram showing an example of an optical system applied to a camera module according to an embodiment of the invention.

FIG. 19 is a table showing lens data of the optical system of FIG. 18.

FIG. 20 is a diagram explaining the aspheric coefficient of the sixth lens of FIGS. 7, 8, and 18.

FIGS. 21a and 21b are diagrams explaining the Zernike coefficient of the aspherical coefficient of FIG. 20.

FIG. 22 is a diagram showing a camera module according to an embodiment applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, a first lens refers to a lens closest to the object side, and a last lens refers to a lens closest to the image side (or sensor surface). The last lens may include a lens adjacent to the image sensor. Unless otherwise specified in the description of the invention, the units for lens radius, thickness/distance, TTL, etc. are all mm. In this specification, a shape of the lens is expressed based on the optical axis of the lens. For example, saying that the object-side surface of the lens is convex or concave means that the object-side surface of the lens is convex or concave around the optical axis, but does not mean that a periphery region of the optical axis is convex or concave. Therefore, even if the object-side surface of the lens is described as convex, a portion around the optical axis on the object-side surface of the lens may be concave or the opposite shape. In this specification, it should be noted that the thickness and radius of curvature of the lens are measured based on the optical axis of the lens. In other words, a convex lens surface may mean that the lens surface in the region corresponding to the optical axis has a convex shape, and a concave lens surface means that the lens surface in the region corresponding to the optical axis has a concave shape. Additionally, “object-side surface” may refer to the surface of the lens facing the object side based on the optical axis, and “sensor-side surface” may refer to the surface of the lens facing the sensor side based on the optical axis.

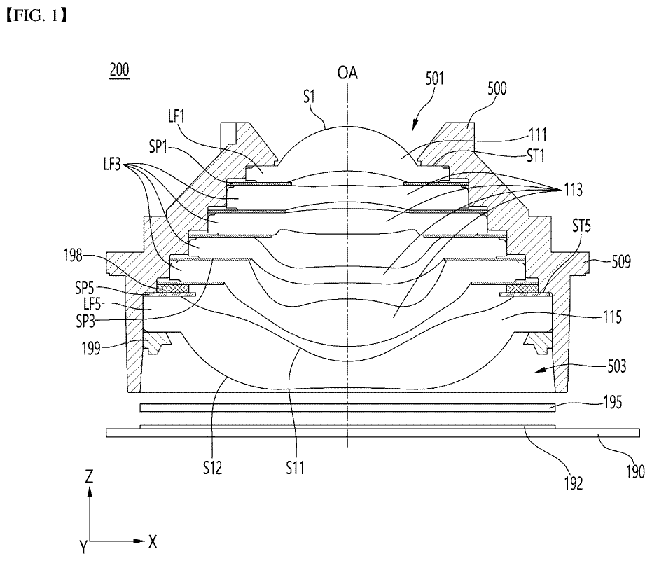

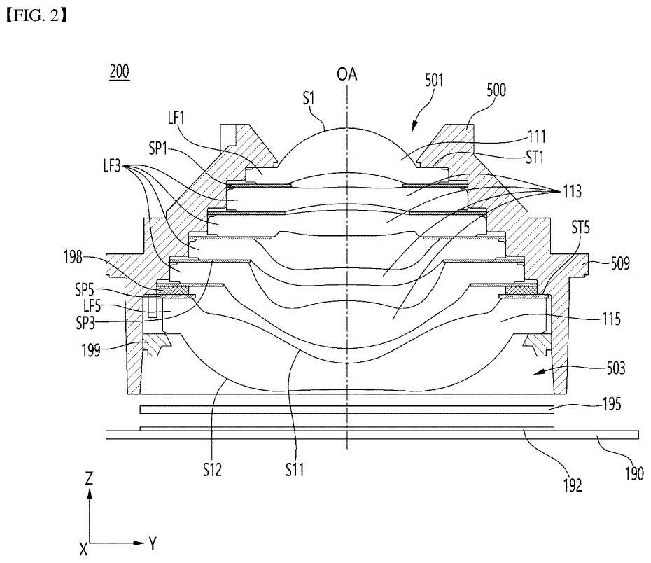

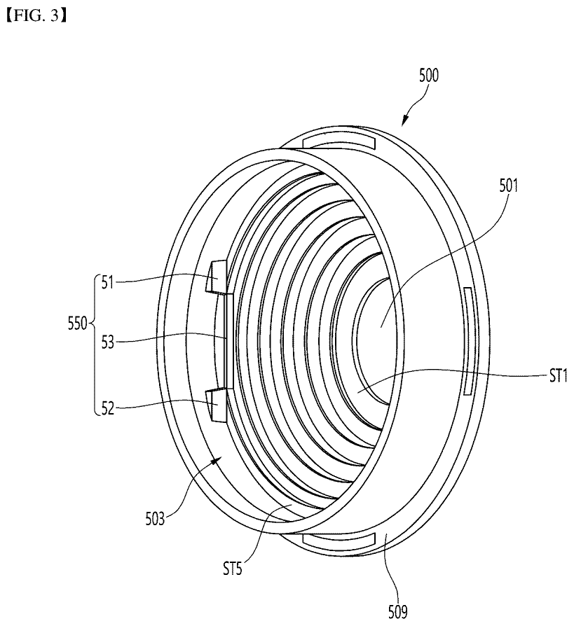

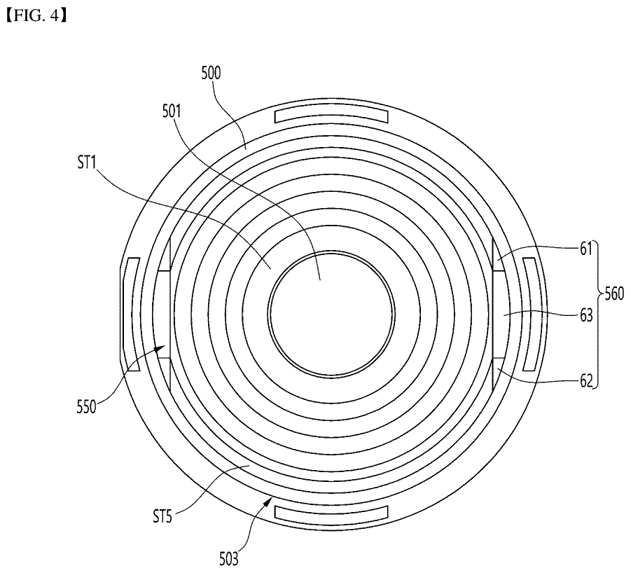

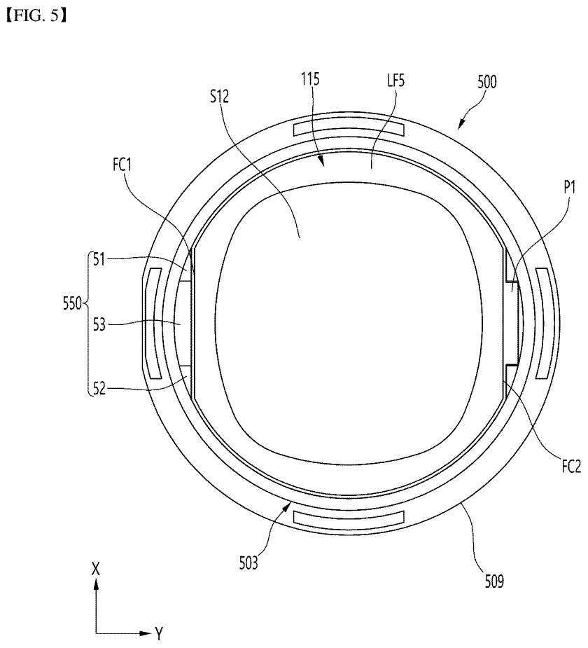

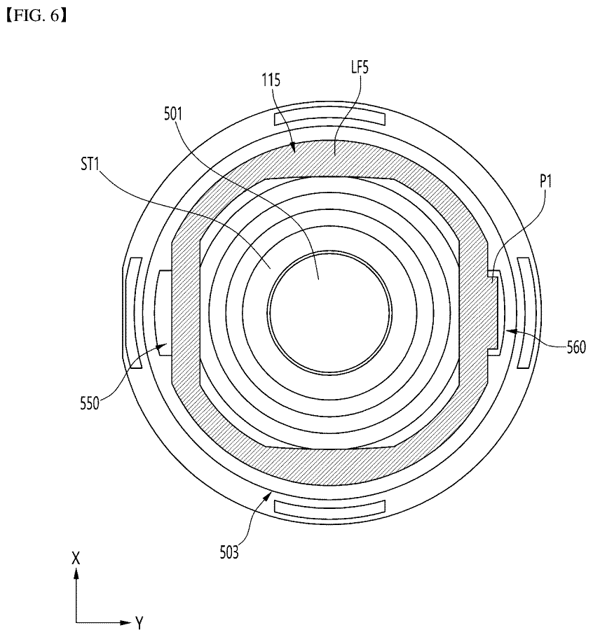

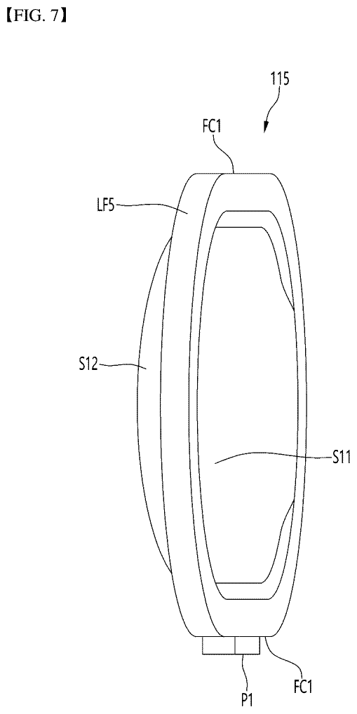

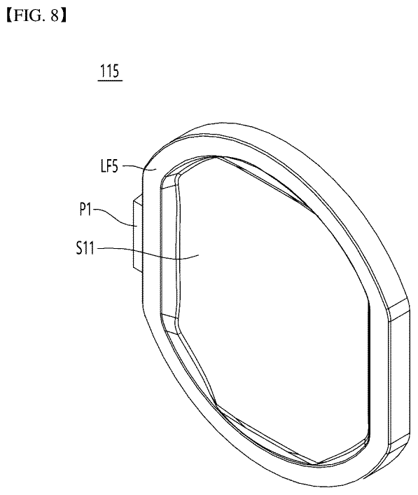

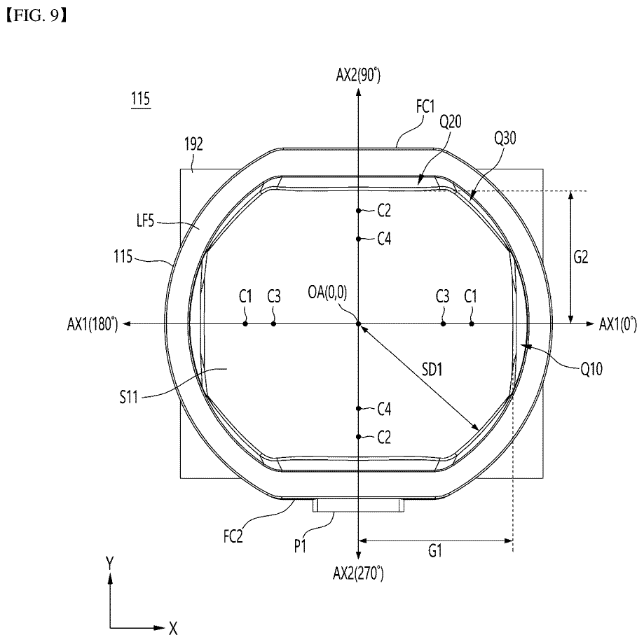

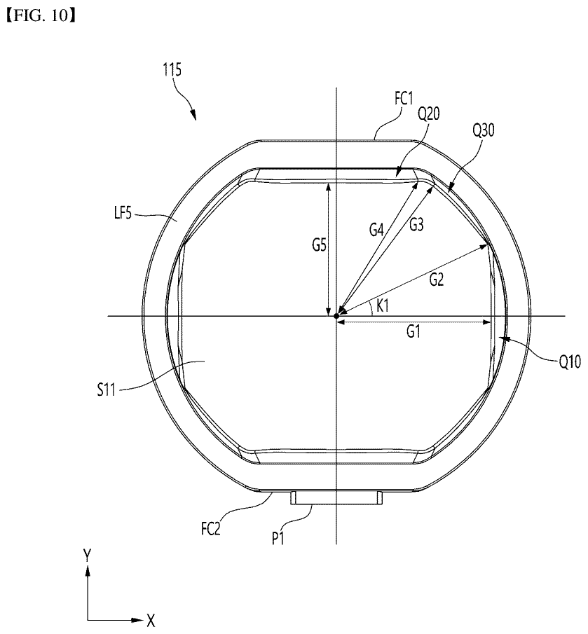

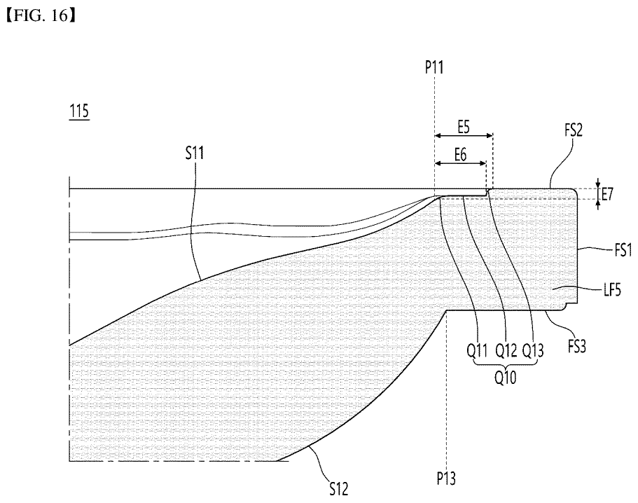

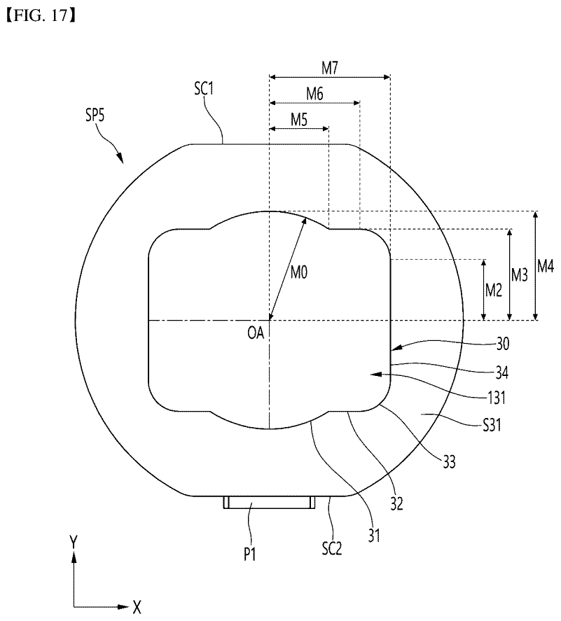

FIGS. 1 and 2 are examples of side cross-sectional views in the first and second directions orthogonal to each other of a camera module according to an embodiment of the invention, FIG. 3 is a perspective view of the lens barrel of the camera module of FIG. 1, FIGS. 4 and 5 is a bottom view of the lens barrel in the camera module, FIG. 6 is an example of coupling the flange portion of the last lens to the lens barrel in FIG. 5, FIGS. 7 and 8 are perspective views of the last lens in FIG. 5, FIGS. 9 and 10 are the object-side view of the last lens in FIGS. 7 and 8, FIGS. 11 and 12 are the sensor-side views of the last lens of FIGS. 7 and 9, FIGS. 13 and 14 are views for explaining flange portions of a last lens of FIGS. 7 and 8, FIG. 15 is a side cross-sectional view of a last lens of FIGS. 7 and 8 in a first direction, FIG. 16 is a partial cross-sectional view of a last lens of FIGS. 7 and 8 in a second direction, and FIG. 17 is a plan view of a spacer disposed on a last lens according to an embodiment of the invention.

Referring to FIGS. 1 to 17, the camera module 200 according to an embodiment of the invention may include a lens barrel 500, a plurality of lenses 111, 113, and 115 within the lens barrel 500, and spacing maintenance members SP1, SP3, SP5, and 198, a substrate 190, and an image sensor 192. The camera module 200 may include an optical filter 195 between the image sensor 192 and the last lens 115 adjacent to the image sensor 192.

The camera module 200 includes an optical system having a plurality of lenses 111, 113, and 115, and the optical system may have three or more lenses, for example, three to ten lenses stacked. The optical system may include three or more or ten or more solid lenses. The optical system may be an optical system having at least one lens made of plastic, an optical system having at least one lens made of glass, an optical system having all plastic lenses, or an optical system having a mixture of glass lens and plastic lens. For convenience of explanation, the optical system may include a first lens 111 closest to the object side, a last lens or third lens 115 closest to the image sensor 192, and an intermediate lens(s) or second lens 113 disposed between the first and third lenses 111 and 115. The second lens 113 may include one or more lenses, for example, 1 to 8 lenses. The centers of the first to third lenses 111, 113, and 115 may be aligned with the optical axis OA.

The lenses 111, 113, and 115 are coupled to the through hole 501 in the lens barrel 500, and may be coupled, for example, in the object-side direction from the sensor side, in the opposite direction, or in both directions. An example will be given where the lenses 111, 113, and 115 in the through hole 501 of the lens barrel 500 are combined in the object-side direction from the sensor side. Accordingly, a lower through hole 503 of the lens barrel 500 may have a wider diameter than an upper through hole.

Step portions ST1 and ST5 may be disposed inside the lens barrel 500 to support the flange portions LF1, LF3, and LF5 of each lens 111, 113, and 115, and spacers SP1, SP3, and SP5, which are spacing maintenance members, may be interposed between the flange portions LF1, LF2, and LF5 of adjacent lenses 111, 113, and 115. The spacers SP1, SP3, and SP5 are disposed on the non-effective region of each lens 111, 113, and 115 to block invalid light and maintain the distance between the lenses 11, 113, and 115. In addition, a thicker light blocking member 198 than the spacer SP5 may be combined on some lenses, i.e., on the flange portion LF5 of the last third lens 115, to maintain the distance between the overall lenses. The spacing maintenance members SP1, SP3, SP5, and 198 may have passing holes disposed inside them so that they can be disposed around the outer periphery of the effective regions of the lenses 111, 113, and 115.

Each of the lenses 111, 113, and 115 may include an effective region having an effective diameter through which light is incident, and a non-effective region outside the effective region. The flange portions LF1, LF3, LF5 of the lenses 111, 113, and 115 may be non-effective regions. The non-effective region may be a region where light is blocked by a spacer SP1, SP3, and SP5. The flange portions LF1, FL3, and LF5 may extend in the effective region of the lenses 111, 113, and 115 in a direction orthogonal to the optical axis OA, in a radial direction, or in a circumferential direction.

A support member 199 may be disposed around the lower portion of the third lens 115, and the support member 199 may support the third lens 115 or maintain a distance from the optical filter 195. Here, the outer portion of the third lens 115 may be bonded to the inner surface of the lens barrel 500 with an adhesive.

A diameter of the first lens 111 may be smaller than a diameter of the second lens, and the diameter of the second lens may be smaller than a diameter of the third lens 115. The diameters of the first, second, and third lenses 111, 113, and 115 may gradually increase from the object side to the sensor side. The external shape of the first, second, and third lenses 111, 113, and 115 stacked may be a pyramid shape or a polygon shape. As another example, when the optical system is divided into two lens groups, an object-side first lens group may have a diameter that decreases toward the sensor side, and a sensor-side second lens group may have a diameter that increases toward the sensor side. The first lens 111 is a lens closest to the subject, and at least one or both of an object-side surface S1 from which light is incident and a sensor-side surface from which light is emitted may be spherical or aspherical. The first lens 111 may have positive (+) or negative (−) refractive power, and preferably may have positive (+) refractive power. The object-side surface S1 of the first lens 111 may be convex, and the sensor-side surface may be concave. The first lens 111 may be made of plastic or glass, for example, may be made of plastic.

The lenses in the second lens 113 may have positive (+) refractive power and/or negative (−) refractive power. At least one or both of the lenses of the second lens 113 may have an aspherical object-side surface and a sensor-side surface, and may be made of glass or plastic.

The third lens 115 may have positive (+) or negative (−) refractive power, and preferably may have negative (−) refractive power. The third lens 115 may be made of plastic. At least one or both of the object-side first surface S11 and the sensor-side second surface S12 of the third lens 115 may be spherical or aspherical, for example, both may be aspherical. The first surface S11 may be concave on the optical axis OA, and the second surface S12 may be concave on the optical axis OA. As another example, the first surface S11 may be concave on the optical axis OA, and the second surface S12 may be convex on the optical axis OA. The first surface S11 of the third lens 115 may include at least one critical point in a region from the optical axis OA to the end of the effective region. The second surface S12 may include at least one critical point in a region from the optical axis OA to the end of the effective region. The critical point is a point at which the sign of the slope value with respect to the optical axis OA and the direction orthogonal to the optical axis OA changes from positive (+) to negative (−) or from negative (−) to positive (+), and may means a point where the slope value is 0. Additionally, the critical point may be a point where the slope value of a tangent line passing through the lens surface increases and then decreases, or a point where it decreases and then increases.

The image sensor 192 may be disposed on the substrate 190. The image sensor 192 may be mounted, seated, contacted, fixed, temporarily fixed, supported, or coupled to a plane of the substrate 190 that intersects the optical axis OA. Alternatively, according to another embodiment, a groove or hole (not shown) capable of accommodating the image sensor 192 may be formed in the substrate 190, and the embodiment is not limited to a specific form in which the image sensor 192 is disposed on the substrate 190. The substrate 190 may be a rigid PCB or FPCB. The image sensor 192 may perform a function of converting light passing through the lenses 111, 113, and 115 into image data. The image sensor 192 may be one of a charge coupled device (CCD), complementary metal-oxide semiconductor (CMOS), CPD, or CID. When there are multiple image sensors 192, one may be a color (RGB) sensor and the other may be a black-and-white sensor.

The optical filter 195 may be disposed between the third lens 115 and the image sensor 192. The optical filter 195 may filter light corresponding to a specific wavelength range for light passing through the lenses 111, 113, and 115. The optical filter 195 may be an infrared (IR) blocking filter that blocks infrared rays or an ultraviolet (UV) blocking filter that blocks ultraviolet rays, but the embodiment is not limited thereto. The optical filter 195 may be placed on the image sensor 192.

A housing (not shown) covers an outside of the lens barrel 500, surrounds the image sensor 192, and protects the image sensor 192 from external foreign substances or impacts.

In an embodiment of the invention, at least one of the first lens 111, the second lens 113, and the third lens 115 may be a freeform lens. For example, the third lens 115 closest to the image sensor 192 may be a freeform lens. The effective region of the object-side first surface S11 of the third lens 115 may be rotationally asymmetric with respect to the optical axis or the center thereof. The effective region of the sensor-side second surface S12 of the third lens 115 may be rotationally asymmetric with respect to the optical axis or the center thereof. The freeform lens is an effective region having a freeform surface, and at least one or both of the object-side first surface S11 and the sensor-side second surface S12 of the third lens 115 may be formed as a freeform surface.

The third lens 115 may have a double plane symmetrical shape. In detail, the third lens 115 may have a shape that is symmetrical to the X-Z plane and symmetrical to the Y-Z plane. Additionally, the third lens 115 may have a shape that is asymmetrical to the X-Y plane. That is, the third lens 115 may have a shape that is symmetrical about the X-axis or Y-axis and asymmetrical about the Z-axis. In the X-axis (first direction), Y-axis direction (second direction), and Z-axis direction (third direction) shown in the drawing, the Z-axis direction (third direction) may mean the optical axis direction or a direction parallel to the optical axis OA direction. The first direction X may be orthogonal to the second and third directions Y and Z, and the second direction Y may be orthogonal to the first and third directions X and Z. The X-axis direction (first direction), the Y-axis direction (second direction), and the Z-axis direction (third direction) may be defined as directions orthogonal to each other in the same plane or different planes.

Here, the first direction X may be a long side direction of the image sensor 192, and the second direction Y may be a short side direction of the image sensor 192. The length of the image sensor 192 in the first direction X may be greater than that in the second direction, and the length of the image sensor 192 in the diagonal direction may be the largest. The image sensor 192 may have a length ratio of 3:2, 4:3, or 16:9 in the first and second directions X and Y.

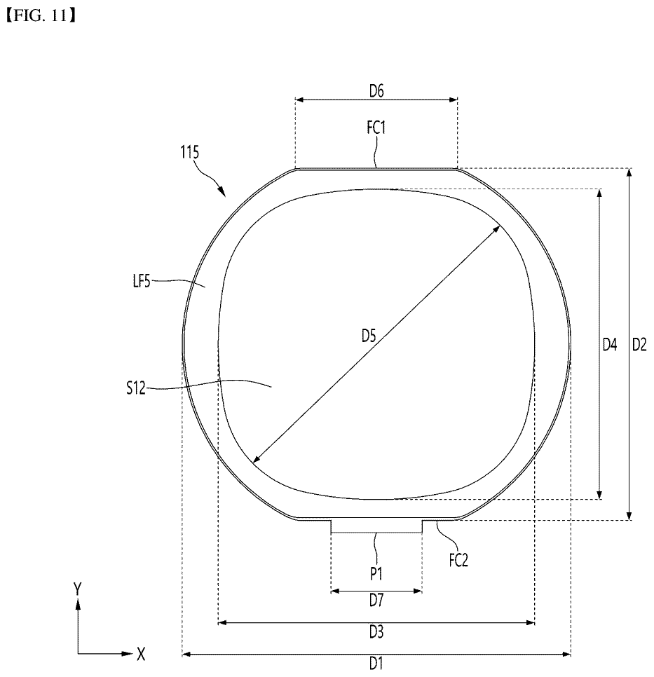

The external shape of the third lens 115 may have a rotationally asymmetric shape with respect to the optical axis OA or the center thereof. Additionally, the external shape of the third lens 115 may be non-circular. As shown in FIG. 11, the maximum length D1 of the third lens 115 in the first direction X may be greater than the maximum length D2 of the third lens 115 in the second direction Y. A length D3 of the effective region in the first direction X on the second surface S12 of the third lens 115 may be greater than a length D4 of the effective region in the second direction Y, and a length D5 of the effective region in the diagonal direction may be larger than the length D4 in the short side direction. Here, a width D7 of the outer protrusion P1 may be smaller than a width D6 of the first and second straight portions FC1 and FC2, and may disposed, for example, in a range of 50% or more, or 50% to 90% of D6. Additionally, the protrusion length of the outer protrusion P1 may be 10% or less of the diameter D1 of the third lens 115, for example, in the range of 8% to 10%. The width D6 of the first and second straight portions FC1 and FC2 may be 42% or less of the diameter D1 of the third lens 115, for example, in the range of 32% to 42%. By providing the width D7, protrusion length, and thickness of the outer protrusion P1 within the above range, it can be stably seated and supported on the seating portion 550 and 560. The thickness of the outer protrusion P1 may be 50% or more, for example, 50% to 80% of the thickness E0 of the flange portion LF5, and the outer protrusion P1 may deviate from the seating portion 550 and 560 due to this range and may be tightly coupled to the inner surface of the guide protrusions 52 and 53.

As shown in FIGS. 7 to 10, the third lens 115 may have a first straight portion FC1 on one side of the outer arc portion in the second direction Y and a second straight portion FC2 on the other side. The first and second straight portions FC1 and FC2 may be disposed on both sides of the third lens 115 in the second direction Y and may extend in a straight line inside the virtual curve extending the arc portion. The first and second straight portions FC1 and FC2 may connect arc portions on both sides in the first direction. Any one of the first and second straight portions FC1 and FC2 may have an outer protrusion P1. The outer protrusion P1 may protrude outward from any one of the first and second straight portions FC1 and FC2. The outer protrusion P1 may be placed inside the virtual arc or curve passing the outermost edge of the third lens 115. Accordingly, the outer protrusion P1 can be seated inside the lens barrel 500 and the size of the lens barrel 500 cannot be increased.

As shown in FIGS. 3 to 6, the lens barrel 500 may include a plurality of seating portions 550 and 560 into which the outer protrusion P1 can be inserted. The plurality of seating portions 550 and 560 may be disposed on opposite sides of each other. The plurality of seating portions 550 and 560 may include a first seating portion 550 disposed on one side in the second direction Y of the lens barrel 500 and a second seating portion 560 disposed on the other side in the second direction Y. Each of the first seating portion 550 and the second seating portion 560 may have a concave seating groove 51, and guide protrusions 52 and 53 may be inserted into one or both sides of the seating groove 51. The seating groove 51 may have a bottom deeper than the surfaces of the guide protrusions 52 and 53 or deeper toward the object. By disposing the first seating portion 550 and the second seating portion 560 at the lower portion of the lens barrel 500, when mounting the third lens 115 closest to the image sensor 192, the outer protrusion P1 of the third lens 115 may be seated in the seating groove 51 of any one of the first seating portion 550 and the second seating portion 560. That is, the first seating portion 550 and the second seating portion 560 identify the coupling direction of the outer protrusion P1 of the third lens 115 and may guide it so that it can be seated in a certain region.

The outer lines of each of the first seating portion 550 and the second seating portion 560 may be formed as a curve along the inner radial direction of the lens barrel 500, and the first and second seating portions 550 and 560 may be formed in a curved line. The third lens 115 may be disposed in both regions of the third step portion ST5 where it is seated. The outer lines of the first and second seating portions 550 and 560 may be disposed within a virtual arc region of the outer line of the third lens 115. The bottom (lower surface) of the seating grooves 51 of the first seating portion 550 and the second seating portion 560 may be located lower toward the sensor than the bottom of the third step portion ST5. The bottom (lower surface) of the seating grooves 51 of the first seating portion 550 and the second seating portion 560 may be positioned higher toward the object than the lower surfaces of the guide protrusions 52 and 53.

As shown in FIG. 9, the first surface S11 of the third lens 115 may have a non-circular shape. A virtual axis for setting the coordinates of the first surface S11 may be set on the first surface S11 of the third lens 115. In detail, when viewed from the first surface S11 of the third lens 115, a first axis AX1 may have an angle of 0 degrees and 180 degrees with respect to the optical axis OA, and may be the X-axis, a second axis AX2 is the Y axis and may have angles of 90 degrees and 270 degrees. The first axis AX1 may be defined as a direction parallel to the longitudinal direction of the long axis of the image sensor 192. The second axis AX2 may be defined as a direction parallel to the longitudinal direction of the minor axis of the image sensor 192.

A plurality of coordinates respectively set on the first axis AX1 and the second axis AX2 may be set on the first surface S11 of the third lens 115. In detail, the first surface S11 of the third lens 115 may have a first coordinate C1 and a third coordinate C3 set on the first axis AX1. In detail, the first surface S11 of the third lens 115 may be set a first coordinate C1 having a coordinate of (+A, 0) and a third coordinate C3 having a coordinate of (+B, 0) on the first axis AX1. The first surface S11 of the third lens 115 may have a first sag value at the first coordinate C1, and a third sag value at the third coordinate C3. Additionally, a second coordinate C2 and a fourth coordinate C4 may be set on the second axis AX2. In detail, a second coordinate C2 having a coordinate of (0, +A) and a fourth coordinate C4 having a coordinate of (0, +B) may be set on the second axis AX2.

The first and second coordinates C1 and C2 may have different sag values when the distance from the optical axis OA is the same. The third and fourth coordinates C3 and C4 may have different sag values when the distance from the optical axis OA is the same. Here, the sag values at the first coordinates C1 on both sides located on the first axis AX1 based on the optical axis OA may be the same, and the sag values at the third coordinates C3 on both sides may be the same. Additionally, the sag values at the second coordinates C2 on both sides located on the second axis AX2 based on the optical axis OA may be the same, and the sag values at the fourth coordinates C4 on both sides may be the same. Accordingly, the first surface S11 may be symmetrical with respect to the optical axis OA and the first axis, and may be asymmetrical with respect to the first and second axes.

The first surface S11 of the third lens 115 may be provided as a second outer portion Q20 in which an outer line is provided as the form of a straight line inside each of the first straight portion FC1 and the second straight portion FC2, and may be provided as a straight first outer portion Q10 on both sides of the first direction X, and a third outer portion Q30 having a curved form may be disposed between the first and second outer portions Q10 and Q20, respectively. On the optical axis, the length SIRI of the first outer portion Q10 may be shorter than the length S1R2 of the second outer portion Q20. In the distances from the optical axis OA to the first, second, and third outer portions Q10, Q20, and Q30, the third distance SDI from the optical axis OA to the third outer portion Q30 is the largest, the first distance G1 from the optical axis OA to the first outer portion Q10 may be greater than the second distance Q2 from the optical axis OA to the second outer portion Q20. The inner region of the first, second, and third outer portions Q10, Q20, and Q30 may be an effective region, and the outer region may be a non-effective region.

The first surface S11 of the third lens 115 has a first distance G1 from the optical axis OA to an end of the effective region in the first direction greater than the second distance G2 from the optical axis OA to the end of the effective region in the second direction. One end of the third outer portion Q30 is adjacent to the first outer portion Q10 and may be disposed farther from the optical axis OA than the other end adjacent to the second outer portion Q20. The maximum distance G5 from the optical axis OA to the end of the effective region on the first surface S11 of the third lens 115 may be located at an angle K1 in the range of 28 degrees±3 degrees based on the first direction X. The point of the maximum distance G5 may be a boundary point between one end of the first outer portion Q10 and the third outer portion Q30. Here, in the third outer portion Q30 with respect to the first surface S11 of the third lens 115, a distance G3 of a point adjacent to the first outer portion Q10 with respect to the optical axis OA may be greater than the distance G4 to a point adjacent to the second outer portion Q20. The position of the distance G3 may be located at a position of 50 degrees or more from the optical axis OA with respect to the first axis X.

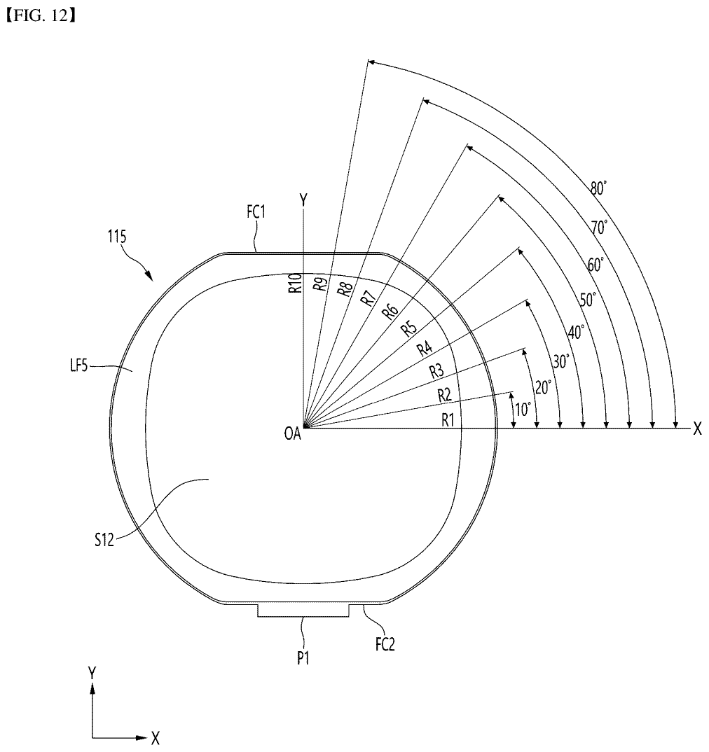

As shown in FIGS. 11 and 12, the second surface S12 of the third lens 115 may have a non-circular shape. The length D1 of the second surface S12 in the first direction may be greater than the length D2 of the second direction, and the length in the diagonal direction may be the largest. Here, In the effective region of the second surface S12, when measuring the distances R1-R10 of points that increase by 10 degrees based on the first direction X, the distance R1 to the end of the X-axis based on the optical axis is greater than the distance R10 to the end of the Y-axis, the distance R2 at 10 degrees based on the optical axis is greater than the distance R1 at 0 degrees (e.g., X axis) and less than the distance R3 at 20 degrees, the distance R4 at 30 degrees based on the optical axis is greater than the distance R3 at 20 degrees and less than the distance R5 at 40 degrees, and the distance R6 at 50 degrees based on the optical axis may be greater than the distance R5 at 40 degrees and greater than the distance R7 at 60 degrees. That is, the effective distance R6 from the X-axis to a point having an angle of 50°+3 based on the optical axis OA may be the maximum. The distance R8 at 70 degrees is smaller than the distance R7 at 60 degrees and greater than the distance R9 at 80 degrees, and the distance R9 at 80 degrees may be greater than the distance R10 to the end of the Y axis at 90 degrees. The angle to the point having the maximum effective distance of the second surface S12 with respect to the first direction X based on the center or optical axis of the third lens 115 may be greater than the angle to the point of the maximum effective distance of the first surface S11.

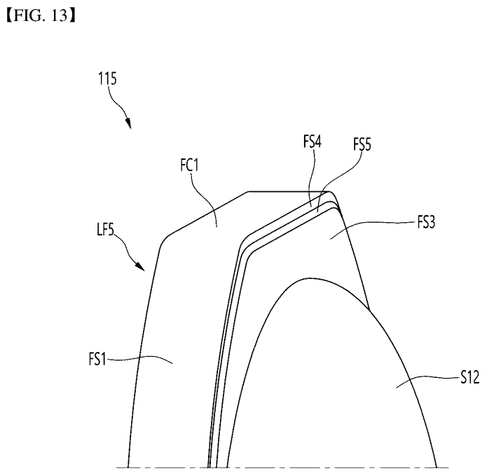

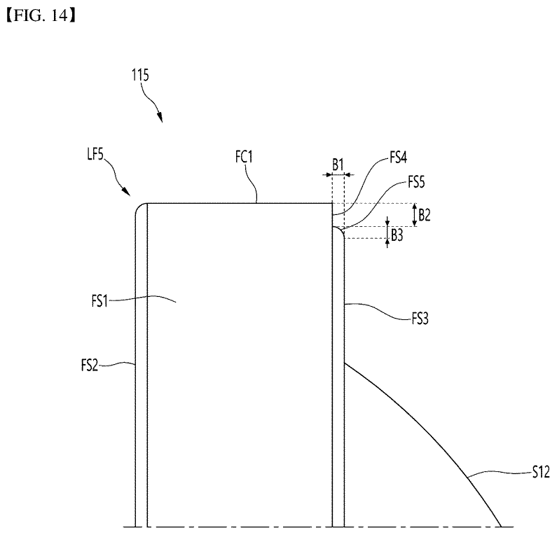

Referring to FIGS. 13 and 14, the flange portion LF5 of the third lens 115 has opposite outer lower surfaces FS3 and outer upper surfaces FS2 that are bent to the outer surface FS1, and the outer lower surfaces FS3 is a sensor-side surface and is located on the outer circumference of the first surface S11, and the outer upper surface FS2 is an object-side surface and may be the outer circumference of the second surface S12. The region between the outer lower surface FS3 of the flange portion LF5 and the outer surface FS1 may have a stepped region FS4. The stepped region FS4 is disposed at a higher position than the outer lower surface FS2, and may have a width B2 of 0.01 mm or less and a depth B1 smaller than the width B2. A region between the stepped region FS4 and the outer lower surface FS3 has a curved surface FS5, and the curved surface FS4 may have a width B3 of 0.05 mm or less and a radius of 0.05 mm or less. By providing a stepped region FS4 between the outer lower surface FS3 and the outer surface FS1 of the flange portion LF5, protrusions such as burs may not protrude or a coupling failure may be prevented when the third lens 115 is injected.

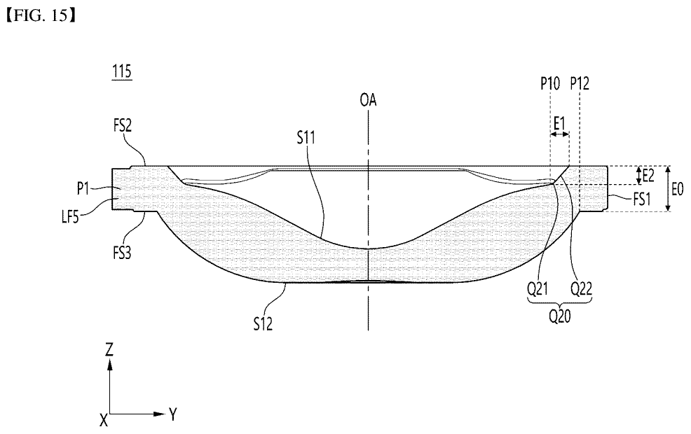

Referring to FIG. 15, a region between the end of the first surface S11 in the second direction Y of the third lens 115 and the flange portion LF5 includes a second outer portion Q20, and the second outer portion Q20 may include a first inclined surface Q21 inclined at an end of the effective region and a second inclined surface Q22 inclined at an angle greater than the angle of the first inclined surface Q21. The horizontal width of the second inclined surface Q22 may be greater than the horizontal width of the first inclined surface Q21. The second outer portion Q20 may be located further inside the end P12 of the effective region of the flange portion LF5. The maximum depth E2 of the second outer portion Q20 may be less than ½ or in a range of ½ to ¼ of the thickness E0 of the flange portion LF5.

Referring to FIG. 16, a region between the end of the first surface S11 in the first direction X of the third lens 115 and the flange portion LF5 includes a first outer portion Q10, and the first outer portion Q10 may have a different shape from the second outer portion Q20. The first outer portion Q10 may include a first curved surface Q11 extending outward from the end of the effective region, a second curved surface Q13 extending inward from the outer upper surface FS2 of the flange portion LF5, and a straight portion or a horizontally extending flat surface Q12 between the first and second curved surfaces Q11 and Q13. The width E5 of the flat surface Q12 may be greater than the width of the first and second curved surfaces Q11 and Q13 or the sum of these widths. The maximum length E5 of the first outer portion Q10 may be greater than the length E1 of the second outer portion Q20, for example, 0.25 mm or more or in the range of 0.25 mm to 0.3 mm. The depth E7 of the first outer portion Q10 may be lower than the depth E2 of the second outer portion Q20, for example, 0.08 mm or less, for example, in the range of 0.03 mm to 0.08 mm. This makes the depth of the second outer portion Q20 located in the minor axis direction of the first surface S11 of the third lens 115 deeper than the depth of the first outer portion Q10 located in the long axis direction, so that the depth of the effective region Length and height can be adjusted. When the first outer portion Q10 does not have the second curved surface Q13, the minimum length E6 may be 0.26 mm or less. The first outer portion Q10 may vertically overlap the end of the effective region of the second surface S12 and the lower surface FS3 of the flange portion LF5.

Referring to FIGS. 17 and 10, the third spacer SP5 may be disposed on the flange portion LF5 of the object-side first surface S11 of the third lens 115. The third spacer SP5 may have a non-circular outer shape. An internal penetration hole 131 of the third spacer SP5 may have a non-circular shape. The third spacer SP5 may include a third straight portion SC1 disposed on the first straight portion FC1, and a second straight portion SC2 disposed on the second straight portion FC2. The third straight portion SC1 and the fourth straight portion SC2 may be disposed between outer arc portions.

In the peripheral surface 30 of the penetration hole 131 from the lower surface S31 of the third spacer SP5, a first curved portion 31, a first line portion 32, a second curved portion 33, and a second line portion 34 may be included from the second direction Y to the first direction X with respect to the optical axis OA. The first curved portion 31 is disposed on both sides in the second direction, and may have a radius MO of 1.5 mm or more, and may be larger than the radius of the second curved portion 32. The first line portion 32 extends in a straight line in a first direction between the first and second curved portions 31 and 33, the second line portion 34 extends in a straight line in a second direction, and the length of the first line portion 32 may be shorter than the length of the second line portion 34. The second line portion 34 may extend in a long straight line between the second curved portions 33 disposed on both sides in the second direction. The distance M2 from the first axis X to the other end of the first line portion 32 is in a range of 1 mm±0.2 mm, and the distance M3 to the second line portion 34 is in a range of 1.50 mm+0.2 mm, and the distance M4 to the vertex of the first curved portion 31 may be in the range of 1.80 mm+0.2 mm. The distance M5 from the second axis Y to the end of the first curved portion 31 is in the range of 0.99 mm+0.2 mm, and has a relationship of M5<M2, the distance M6 to the second line portion 32 is in a range of 1.50 mm+0.2 mm and may be the same as M3, and the distance M7 to the second line portion 34 may be in the range of 2 mm+0.2 mm and may have the relationship of M7>M4. A protrusion P1 may be exposed on the outside of the fourth straight portion SC2 of the third spacer SP5.

An embodiment of the invention may improve optical performance up to the periphery of the image sensor or a region of the diagonal direction by forming a freeform surface having a freeform shape on the object-side surface and sensor-side surface of the lens closest to the image sensor 192. Additionally, by providing a non-circular shape for the penetration hole 131 of the spacer SP5 on the freeform lens, unnecessary light can be effectively blocked.

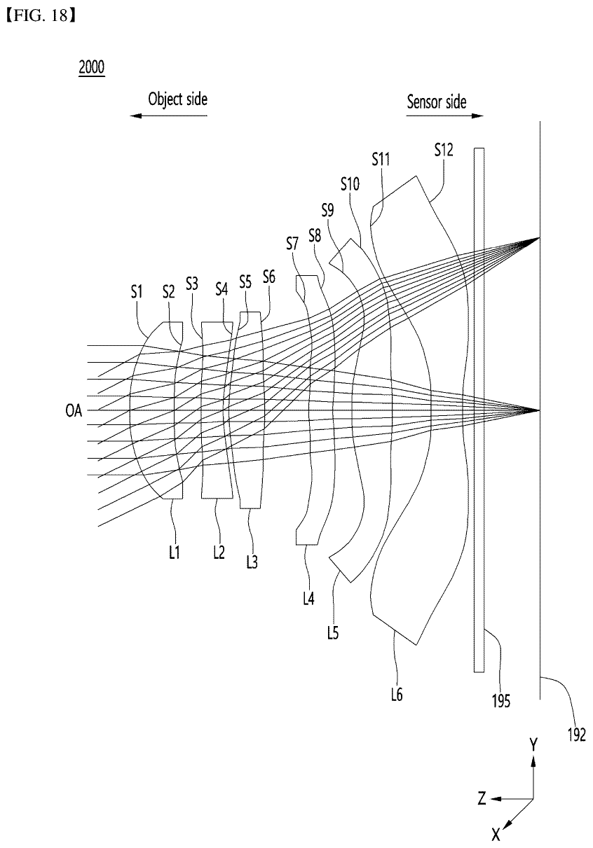

Referring to FIGS. 18 to 21, the optical system of the camera module according to an embodiment of the invention will be described.

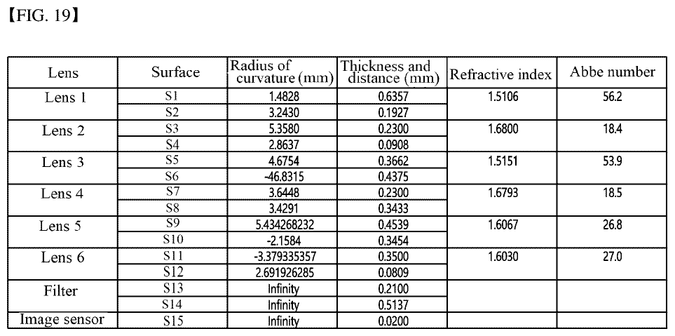

As shown in FIG. 18, the optical system 2000 may include a first lens L1, a second lens L2, a third lens L3, a fourth lens L4, a fifth lens L5, a sixth lens L6, and an image sensor 192 that are sequentially arranged from the object side to the sensor side. The first to sixth lenses L1 to L6 may be spaced apart from each other and sequentially arranged along the optical axis OA. The optical system 2000 according to the above embodiment may include an aperture stop (not shown). The aperture stop may be disposed between the first lens L1 and the second lens L2, or may be on the outer perimeter between other lenses. Alternatively, the sensor-side surface or object-side surface of the first lens L1 may be an aperture stop. The spacer SP5 in FIG. 17 may be disposed on the outer circumference between the fifth lens L5 and the sixth lens L6. Additionally, the third lens 115 in FIGS. 1 to 16 may be the sixth lens L6. As shown in FIG. 19, the first to sixth lenses L1 to L6 may have a radius of curvature of a set value, a thickness at the optical axis, an optical axis distance between adjacent lenses, a refractive index, and Abbe number, respectively.

The first lens L1 may have positive (+) refractive power on the optical axis. The first surface S1 of the first lens L1 may be convex with respect to the object-side surface on the optical axis, and the second surface S2 may be concave with respect to the sensor-side surface on the optical axis. The first lens L1 may have a meniscus shape convex on the optical axis toward the object as a whole. The first surface S1 may be an aspherical surface, and the second surface S2 may be an aspherical surface. The second lens L2 may have negative refractive power on the optical axis. The third surface S3 of the second lens L2 may be convex with respect to the object-side surface on the optical axis, and the fourth surface S4 may be concave with respect to the sensor-side surface on the optical axis. The second lens L2 may have a meniscus shape convex on the optical axis toward the object as a whole. The third surface S3 may be an aspherical surface, and the fourth surface S4 may be an aspherical surface. The third lens L3 may have positive (+) refractive power on the optical axis. The fifth surface S5 of the third lens L3 may be convex with respect to the object-side surface on the optical axis, and the sixth surface S6 may be convex with respect to the sensor-side surface on the optical axis. The third lens L3 may have a shape in which both sides are convex on the optical axis as a whole. The fifth surface S5 may be an aspherical surface, and the sixth surface S6 may be an aspherical surface.

The fourth lens L4 may have negative refractive power on the optical axis. The seventh surface S7 of the fourth lens L4 may be convex with respect to the object-side surface on the optical axis, and the eighth surface S8 may be concave with respect to the sensor-side surface on the optical axis. The fourth lens LA may have a meniscus shape convex from the optical axis toward the object as whole. The seventh surface S7 may be an aspherical surface, and the eighth surface S8 may be an aspherical surface. The fifth lens L5 may have positive (+) refractive power on the optical axis. The ninth surface S9 of the fifth lens L5 may be convex with respect to the object-side surface on the optical axis, and the tenth surface S10 may be convex with respect to the sensor-side surface on the optical axis. The fifth lens L5 may have a shape in which both sides are convex at the optical axis as a whole. The ninth surface S9 may be an aspherical surface, and the tenth surface S10 may be an aspherical surface.

The sixth lens L6 may have negative refractive power on the optical axis. The eleventh surface S11 of the sixth lens L6 may be concave with respect to the object-side surface on the optical axis, and the twelfth surface S12 may be concave with respect to the sensor-side surface on the optical axis. The sixth lens L6 may have a shape in which both sides are concave at the optical axis as a whole. At least one of the eleventh surface S11 and the twelfth surface S12 may include a freeform surface. In detail, the eleventh surface S11 and the twelfth surface S12 may include freeform surfaces. That is, the sixth lens L6 may be a freeform lens. The sixth lens L6 may correspond to the third lens, which is the last lens shown in FIGS. 1 to 17, and may optionally include the description of FIGS. 1 to 17. Additionally, each lens, spacer, and lens barrel disclosed in FIGS. 1 to 17 can be applied to the optical system of FIGS. 18 to 19.

Radius of curvature of the first to sixth lenses L1-L6, thickness of each lens, distance between each of the lenses, refractive index, and Abbe number may be the same as FIG. 19. The freeform shape of the sixth lens L6 may be defined by the sag value calculated by Equation 1 below.

$$z = \frac{c {r}^{2}}{1 + \sqrt{( 1 + k ) {c}^{2} {r}^{2}}} + {\sum }_{i = 1}^{n} CjZj \qquad [ Equation 1 ]$$

In Equation 1, Z is the sag value of the sixth lens, c is the curvature value of the sixth lens, r is the effective diameter value of the sixth lens, k is the Conic constant, and Cj is the Zernike coefficient at the j order, and Zj is the Zernike basis at order j.

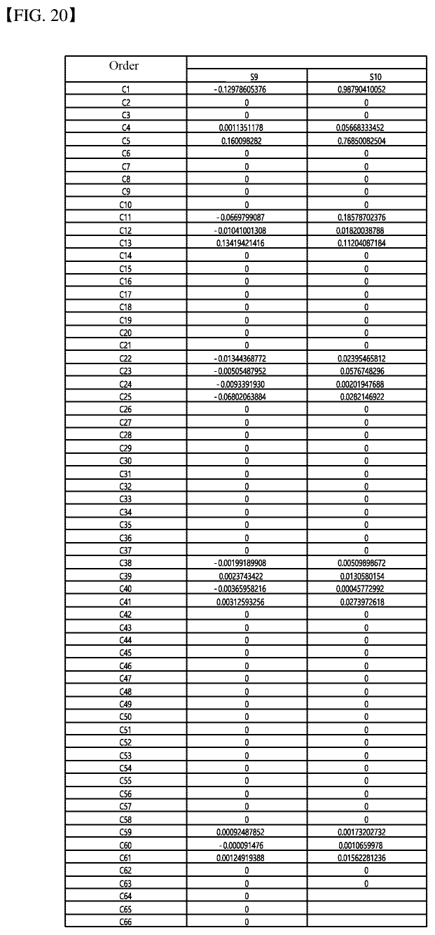

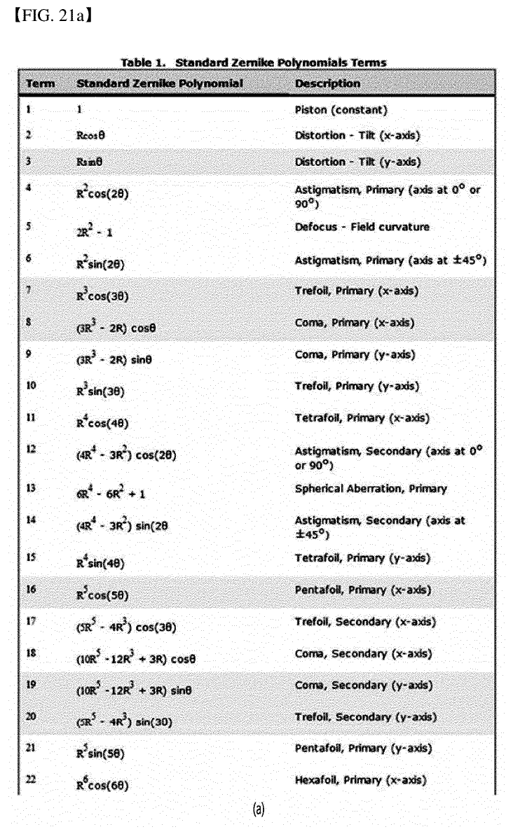

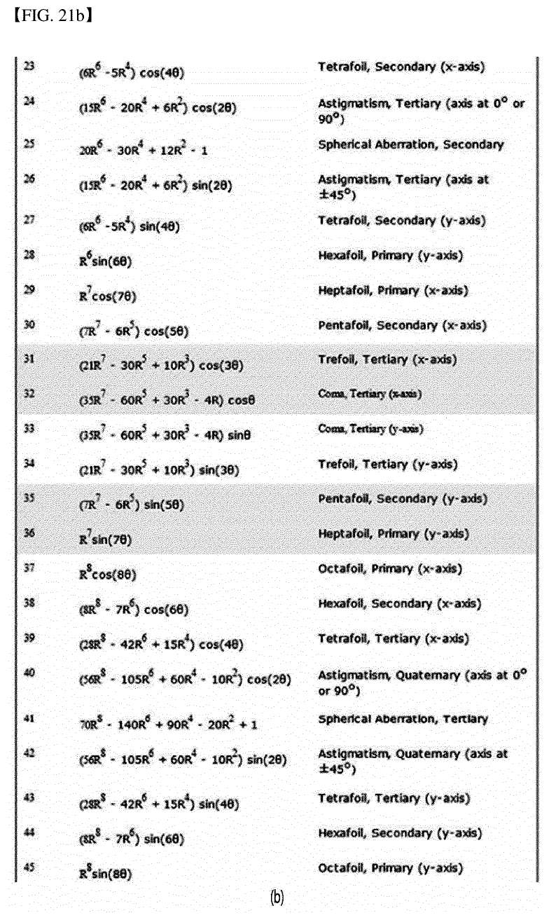

By using the optical system 2000, the peripheral light ratio R1 of the image sensor 192 can be increased to 35% or more, and improved optical characteristics can be achieved. That is, the optical system including the sixth lens L6 may have improved MTF characteristics. Additionally, resolution can be improved by increasing the amount of light incident on the image sensor 192. Here, the ambient light ratio of the image sensor 192 may be defined as the relative ratio of the illuminance in the darkest region to the illuminance in the brightest region among the plurality of regions of the image sensor 192. That is, the ambient light ratio of 35% or more may mean that the illuminance level in the darkest region of the image sensor 192 is 35% or more of the illuminance level in the brightest region of the image sensor 192. The sixth lens L6 may include orders in which the Zernike coefficients of FIG. 20 have a value of 0 and orders that have a value other than 0. In detail, the sixth lens L6 sets all the orders having Sin θ and Cos θ in FIGS. 21a and 21b to a value of 0, and adjusts some of the orders having Cos 2nθ to values other than 0, thereby adjusting the 6 Lenses can be manufactured.

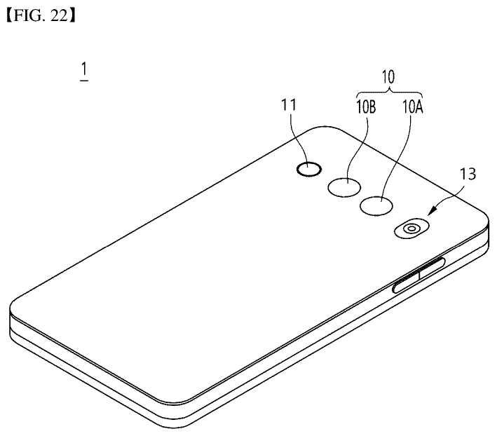

FIG. 22 is a diagram illustrating a camera module according to an embodiment applied to a mobile terminal. Referring to FIG. 22, the mobile terminal 1 may include a camera module 10 provided at the rear. The camera module 10 may include an image capturing function. Additionally, the camera module 10 may include at least one of an auto focus, zoom function, and OIS function. The camera module 10 can process image frames of still images or videos obtained by the image sensor 300 in shooting mode or video call mode. The processed image frame may be displayed on a display unit (not shown) of the mobile terminal 1 and may be stored in a memory (not shown). In addition, although not shown in the drawing, the camera module may be further disposed on the front of the mobile terminal 1. For example, the camera module 10 may include a first camera module 10A and a second camera module 10B. At this time, at least one of the first camera module 10A and the second camera module 10B may include the optical system 1000 disclosed above. Accordingly, the camera module 10 can have a slim structure and have improved distortion and aberration characteristics. Additionally, the camera module 10 can have good optical performance even in the center and periphery portions of the FOV.

Additionally, the mobile terminal 1 may further include an autofocus device 11. The autofocus device 11 may include an autofocus function using a laser. The autofocus device 11 can be mainly used in conditions where the autofocus function using the image of the camera module 10 is deteriorated, for example, in close proximity of 10 m or less or in dark environments. The autofocus device 11 may include a light emitting unit including a vertical cavity surface emitting laser (VCSEL) semiconductor device, and a light receiving unit such as a photo diode that converts light energy into electrical energy. The mobile terminal 1 may further include a flash module 13. The flash module 13 may include a light emitting device inside that emits light. The flash module 13 can be operated by operating a camera of a mobile terminal or by user control.

Features, structures, effects, etc. described in the above embodiments are included in at least one embodiment of the invention, and are not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It can be seen that various modifications and applications that have not been made are possible. For example, each component specifically shown in the embodiment can be implemented by modification. And the differences related to these modifications and applications should be construed as being included in the scope of the invention defined in the appended claims.

1. A camera module comprising:
a lens barrel having a through hole therein; and
an optical system disposed in the through hole of the lens barrel and having a plurality of lenses which an optical axis is aligned from an object side toward a sensor side,
wherein a sensor-side lens closest to an image sensor among the plurality of lenses includes an object-side surface and a sensor-side surface,
wherein the sensor-side lens has a length in a first direction orthogonal to the optical axis longer than a length in a second direction,
wherein the sensor-side lens includes an outer protrusion protruding on one side in the second direction, and
wherein the sensor-side surface of the sensor-side lens has an asymmetrical shape in a shape of a lens surface from the optical axis to an end of an effective region in the first direction and a lens surface from the optical axis to an end of an effective region in the second direction.

2. The camera module of claim 1, wherein the sensor-side lens includes a first straight portion disposed on one side in the second direction with respect to the optical axis and a second straight portion disposed on the other side,
wherein the first and second straight portions are disposed between outer arc portions of the sensor-side lens.

3. The camera module of claim 2, wherein the outer protrusion protrudes outward from the second straight portion,
wherein the outer protrusion is disposed within a virtual circle of the outer arc portion of the sensor-side lens.

4. The camera module of claim 2, wherein the sensor-side surface of the sensor-side lens has a freeform surface, wherein a distance from the optical axis to the end of the effective region in the first direction is greater than a distance to the end of the effective region in the second direction.

5. The camera module of claim 1,
wherein the sensor-side surface of the sensor lens has a maximum effective distance at a point having an angle of 50±3 degrees from an axis extending in the first direction with respect to the optical axis.

6. The camera module of claim 1, wherein an angle to a point having a maximum effective distance of the sensor-side surface with respect to the first direction based on a center of the sensor-side lens is greater than an angle to a point of a maximum effective distance of the object-side surface.

7. The camera module of claim 1, comprising first and second seating portions disposed on both sides of the second direction along a circumference of a lower portion of the lens barrel,
wherein the first and second seating portions include a concave seating groove and guide protrusions on both sides of the seating groove, and
wherein the outer protrusion is inserted into the first or second seating portions.

8. The camera module of claim 7, wherein a bottom of the seating groove is disposed closer to the sensor side than a stepped portion of the lens barrel on which a flange portion of the sensor-side lens is seated.

9. The camera module of claim 1, wherein the object-side surface of the sensor-side lens has a first outer portion between the end of the effective region in the first direction and a flange portion, and a second outer portion between the end of the effective region in the second direction and the flange portion,
wherein the first outer portion and the second outer portion have different shapes.

10. The camera module of claim 9, wherein the second outer portion has a depth lower than that of the first outer portion and has a plurality of inclined surfaces.

11. The camera module of claim 9, wherein the first outer portion has a first curved surface connected to the end of the effective region, a second curved surface connected to the flange portion, and a flat surface between the first and second curved surfaces, and overlaps with a sensor-side surface of the flange portion in vertical direction.

12. The camera module of claim 1, comprising a spacer disposed on a flange portion of the sensor-side lens,
wherein the spacer includes first and second line portions in a form of straight lines on both sides in the second direction.

13. The camera module of claim 12, wherein the spacer has an internal penetration hole of a non-circular shape.

14. The camera module of claim 13, wherein a periphery of the penetration hole of the spacer includes a first curved portion on one side in the second direction, a first line portion extending in a straight line from the first curved portion, a second curved portion in a diagonal region, and a second line portion on one side in the first direction.

15. A camera module comprising:
first to sixth lenses whose optical axes are aligned from an object side toward a sensor side; and
a plurality of spacers each disposed around an outer circumference between the first to sixth lenses,
wherein the sixth lens is closest to an image sensor and has an object-side surface and a sensor-side surface,
wherein a length of the sixth lens in a first direction orthogonal to the optical axis is longer than a length in a second direction,
wherein the sixth lens includes first and second straight portions in a form of straight lines on both sides of the second direction between outer arc portions,
wherein a sensor-side spacer closest to the sixth lens among the plurality of spacers has a penetration hole therein and has third and fourth straight portions on both sides in the second direction, and
wherein at least one of the sensor-side surface and the object-side surface of the sixth lens has a freeform surface.

16. The camera module of claim 15, wherein the sensor-side surface or the object-side surface of the sixth lens has an asymmetrical shape in a shape of a lens surface extending from an end of an effective region in the first direction and a lens surface extending from the optical axis to an end of an effective region in the second direction. A camera module with this asymmetric shape.

17. The camera module of claim 15, wherein the sensor-side spacer has a penetration hole of a non-circular shape.

18. The camera module of claim 15, wherein the sixth lens includes an outer protrusion protruding outward from one of the first and second straight portions,
wherein the outer protrusion protrudes further outward than any one of the third and fourth straight portions of the sensor-side spacer.

19. The camera module of claim 15, wherein both the sensor-side surface and the object-side surface of the sixth lens have freeform surface.

20. A mobile terminal having the camera module of claim 1.
